(19) United States
(12) Patent Application Publication
(10) Pub. No.: US 2017/0078840 A1
(43) Pub. Date: Mar. 16, 2017

(54) TECHNIQUES FOR DYNAMIC GEOGRAPHIC FENCING

(71) Applicant: Amazon Technologies, Inc., Seattle, WA (US)

(72) Inventors: Amit Saurav, Redmond, WA (US); Erin Fern Breslin, Seattle, WA (US); Xiaotong Zhang, Seattle, WA (US); Pradeepa Sekar, Sammamish, WA (US); Margot Johnson, Seattle, WA (US); Samuel Pike Hall, VI, Seattle, WA (US); Patrick James Boyle, Seattle, WA (US); Sherman Gregory Griffin, Seattle, WA (US); Samuel Stevens Heyworth, Seattle, WA (US); Douglas James Herrington, Seattle, WA (US)

(21) Appl. No.: 14/853,152

(22) Filed: Sep. 14, 2015

(51) Int. Cl. H04W 4/02

(52) U.S. Cl. CPC H04W 4/021

(57) ABSTRACT

Techniques are provided herein for utilizing a dynamic geo-fence management engine. The techniques include receiving a set of parameters corresponding to a virtual geographic perimeter. A user may be determined based at least in part on a geographical location of the user and the set of parameters corresponding to the virtual geographic perimeter. A notification for the user may be generated, the notification being formatted according to a push notification service protocol the notification including the set of parameters. The notification may be provided to a remote computing device. Receipt of the notification by the remote computing device may cause the remote computing device to provide, to the user, information related to the virtual geographic perimeter.

### BACKGROUND

It has become common for location-based services to be utilized for marketing purposes. Specifically, geographic fences (geo-fences) are utilized in order to send messages to smartphone users who enter a defined geographic area. Conventional techniques for managing geo-fences can be cumbersome and/or inefficient. A preconfigured geo-fence may operate on a predetermined schedule. Often, changes to a geo-fence utilized by an application require a software update to the application. If scheduling changes occur, and the update is not applied to the application, the pre-initialized geo-fence may lead to disseminating inaccurate information. Such inaccuracy may lead to irritability and frustration for smartphone users and a loss of revenue for the users of the geo-fence. Conventional techniques can make it cumbersome for geo-fences to be used as a marketing tool.

### BRIEF DESCRIPTION OF THE DRAWINGS

Various embodiments in accordance with the present disclosure will be described with reference to the drawings, in which:

FIG. 1 is a schematic diagram illustrating an example environment suitable for implementing aspects of a dynamic geo-fence management engine, in accordance with at least one embodiment;

FIG. 2 is an example architecture of the dynamic geo-fence management engine, in accordance with at least one embodiment;

FIG. 3 is a schematic diagram of the dynamic geo-fence management engine, in accordance with at least one embodiment;

FIG. 4 is a schematic diagram illustrating an example environment suitable for implementing aspects of the dynamic geo-fence management engine, in accordance with at least one embodiment;

FIG. 5 is a schematic diagram illustrating another example environment suitable for implementing aspects of the dynamic geo-fence management engine, in accordance with at least one embodiment;

FIG. 6 is a schematic diagram illustrating an additional example environment suitable for implementing aspects of the dynamic geo-fence management engine, in accordance with at least one embodiment;

FIG. 7 is a schematic diagram illustrating yet another example environment suitable for implementing aspects of the dynamic geo-fence management engine, in accordance with at least one embodiment;

FIG. 8 is a schematic diagram illustrating still one further example environment suitable for implementing aspects of the dynamic geo-fence management engine, in accordance with at least one embodiment;

FIG. 9 is a flowchart illustrating a method for dynamically managing a geo-fence utilizing the dynamic geo-fence management engine, in accordance with at least one embodiment;

FIG. 10 is a flowchart illustrating another method for dynamically managing a geo-fence utilizing the dynamic geo-fence management engine, in accordance with at least one further embodiment;

FIG. 11 is a flowchart illustrating an additional method for dynamically managing a geo-fence utilizing the dynamic geo-fence management engine, in accordance with at least one further embodiment; and

FIG. 12 is a schematic diagram illustrating an example environment for implementing aspects in accordance with at least one embodiment described herein.

### DETAILED DESCRIPTION

Techniques described herein are directed to dynamically managing geo-fences. Examples of a geo-fence, as the term is used herein, include a virtual geographic boundary (e.g., a geographical boundary defined independent of reference to geographic features). An interior area of a geo-fence may be any suitable size and any suitable shape. In at least one example, a system configured to dynamically manage one or more geo-fences may maintain, or otherwise obtain, inventory information and/or fulfillment information related to one or more items offered for consumption on the electronic marketplace. An electronic marketplace, as used herein, is intended to refer to a computer-facilitated market for participants (e.g., buyers and sellers) to conduct transactions including commercial and/or financial transactions. An “item” is intended to refer to a product, a service, a sellable unit, or anything else that may be managed or otherwise physically or electronically stored as inventory.

In a non-limiting example, a merchant may offer a set of items at a mobile location (e.g., a vehicle equipped with an inventory of items) that is to be stationed at various locations, at various times throughout a day. Upon arriving at a particular location (e.g., a street corner), or at another suitable time, location information (e.g., geo-fence parameters) for the vehicle may be communicated to a dynamic geo-fence management engine. Alternately, the scheduled locations of the truck may be identified ahead of time, and shared with the geo-fence management engine. Upon receipt of the location information, the dynamic geo-fence management may identify a number of users (e.g., users submitted opt-in information indicating an interest is such a vehicle). The identity of the users, as well as the location information, may be formatted according to a push notification protocol and communicated to a push notification service for dissemination to the number of the users. Examples of push notifications may include notifications that are formatted according to an Apple® Push Notification Service protocol, a Mozilla® SimplePush protocol, a Google® Cloud Messaging protocol, or the like. The push notification service may provide the location information to the identified users via push notification. A user device, upon receipt of the push notification e.g., a silent or non-silent push notification), may extract and store various geo-fence parameters in local memory. The user device may track its location using, for example, wireless network identification information and/or cellular triangulation data. Upon entering an area corresponding to the geo-fence parameters (e.g., passing a geographic boundary defined by the geo-fence parameters), an application operating on the user device may be notified. The application may determine if it is appropriate to show information related to the push notification on the user device. The application may determine that the user device has not been provided a notification related to the area corresponding to the geo-fence parameters. Additionally, or alternatively, the application may submit information to the dynamic geo-fence management engine, requesting confirmation as to whether or not the application should provide the notification on the user device. In either case, upon determining that the notification should be provided, the application may provide a local notification on the user device that includes information related to the geo-fence parameters (e.g., text such as “Our mobile vehicle is at 5^{th} and Madison, come take a look at our great deals!”). Thus, a geo-fence may be provided by utilizing cellular and wireless components (e.g., antennas) already in use without negatively impacting the battery life of the user device.

As a specific example, the system may enable a user to become aware of a food truck. Food trucks may offer meals throughout a city on various days and at various times. Traditionally, the user would need to visit a webpage offered by the food truck provider in order to determine when the food truck will next be in his neighborhood. Alternatively, the user may be aware of the truck by physically walking by the truck, or through past experience of purchasing meals on a particular day and time. In at least one example, the user may indicate his interest in the food truck and/or food merchant during a registration process. Although the user has not accessed an application related to the food truck, the dynamic geo-fence management engine may utilize a dynamic geo-fence in a similar manner as described above to alert the user of food truck's location. It should be understood that although a food truck is used for illustrative purposes, any mobile location, offering any suitable product or service, may be utilized.

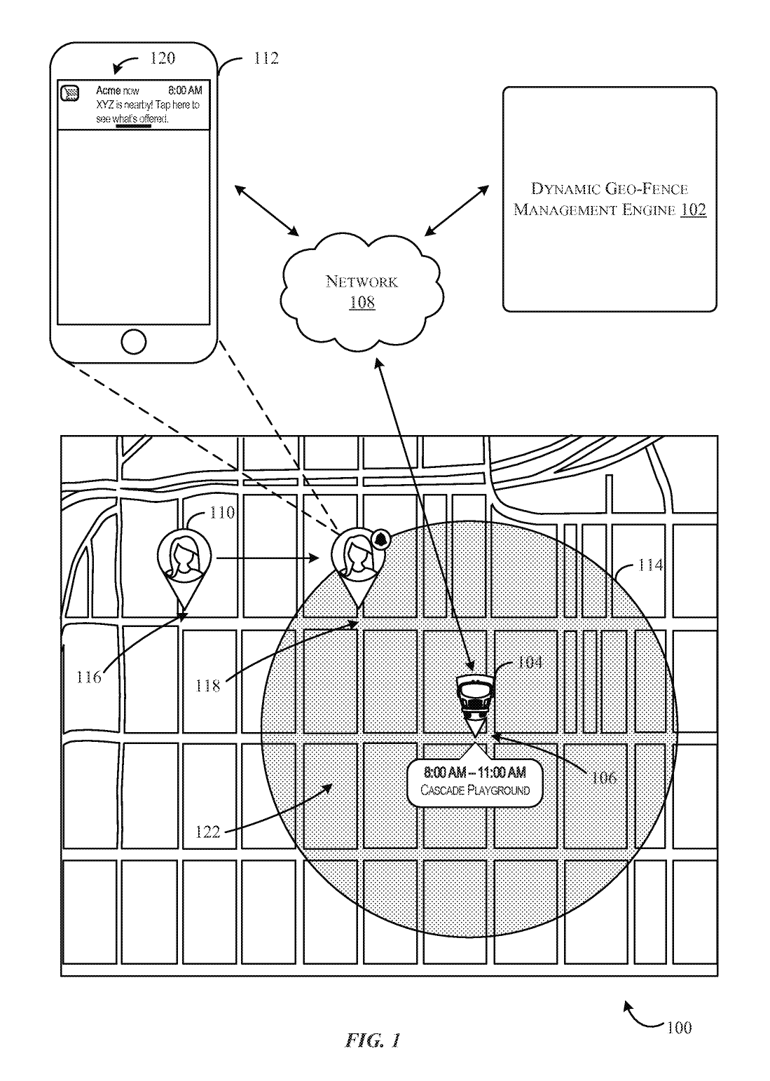

FIG. 1 is a schematic diagram 100 illustrating an example environment suitable for implementing aspects of a dynamic geo-fence management engine 102, in accordance with at least one embodiment. For example, a merchant may deploy a mobile resource (e.g., a truck 104) to a geographic location 106 (e.g., a street corner near Cascade playground). The merchant may intend for the truck 104 to be stationed at the geographic location 106 from the hours of 8:00 AM to 12:00 PM as depicted in FIG. 1. Upon arrival of the truck 104 at the geographic location 106, or at any suitable time, a device (e.g., an electronic device located on or near the truck 104), the driver, the merchant, or any suitable party, may communicate the location of the truck 104 to the dynamic goo-fence management engine 102. Such communication may be transmitted via network 108.

Network 108, and any network described herein, can include any appropriate network, including an intranet, the Internet, a cellular network, a local area network, a wide area network, or any other such network or combination thereof. The communication may be transmitted electronically or physically communicated over, for example, a telephone (e.g., using an automated service). The communication may include, but is not limited to, initialization information such as a geo-fence identifier, a topic category, a location, a message, an active time or time window, a specification of a geographic boundary (e.g., a reference point such as a. latitude, longitude pair and a boundary shape specification such as a radius specifying a circle around the reference point or a set of additional latitude, longitude pairs specifying additional vertices of a polygon), an alert reset indicator, or the like. A geo-fence identifier, for purposes of this disclosure is intended to refer to a unique identifier that corresponds to a particular geo-fence. A topic category may correspond to a merchant, a service, an item, a user, a geographical area, or the like. A location may reference an intended center point of an eventual geo-fence. A message may include text and/or images, for example, that may be eventually delivered to a user device. An active time may indicate a start time and end time or, alternatively, a period of time (e.g., 120 minutes). A radius may correspond to a radial distance from the center point to be used to configure the goo-fence.

Continuing on with the example, upon communicating the arrival of truck 104, dynamic geo-fence management engine 102 may determine an interested user (e.g., user 10). By way of example, the user 110 may have previously indicated (e.g., via a network page managed by the provider of the electronic marketplace) an interest in the truck 104. The dynamic goo-fence management engine 102, having identified the user 110 as an interested user, may utilize a push notification service protocol to transmit the initialization information to the user's electronic device (e.g., a smartphone 112).

Upon receipt of the initialization information, an application executing on the smartphone 112 may store the initialization information in local memory. Storage of such initialization information may case the application to recognize a geographic boundary (e.g., a geo-fence 114). The application executing on the hone 112 may ascertain location information of the smartphone 112 by utilizing, for example, global positioning information, cellular triangulation information, and/or wireless network information. In at least one example, the user 110 may carry smartphone 112 while she walks down a street. Initially, the user 110 may be in the general vicinity of location 116, a point outside of the geo-fence 114. However, the user 110 may wander to a point inside the goo-fence 114 (e.g., location 118). Upon determining that the user 110 has entered the gem-fence 114, the application operating on the smartphone 112 may generate a notification (e.g., a local push notification) to be displayed to the user as depicted at 120. Though location 118 is used as an example, the user 110 may trigger a notification on the smartphone 112 by availing himself to any point inside the geo-fence 114 (depicted by area 122).

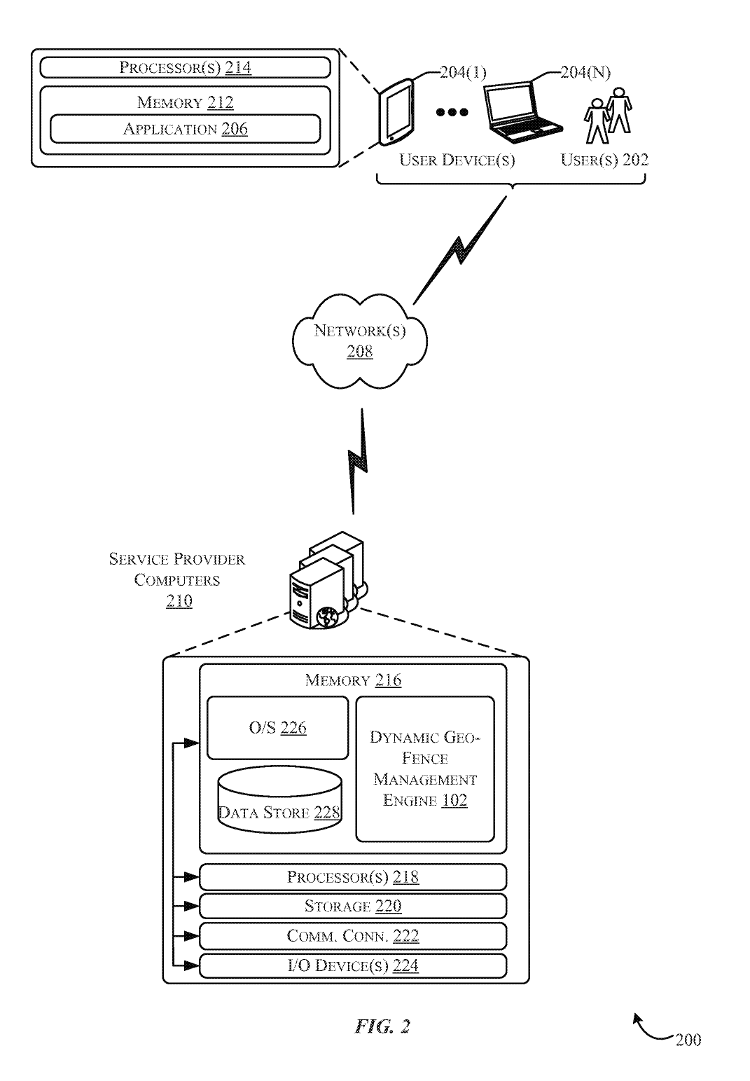

FIG. 2 is an example architecture 200 of the dynamic geo-fence management engine 102 of FIG. 1, in accordance with at least one embodiment. In architecture 200, one or more users 202 may utilize user computing devices 204(1)-(N) (collectively, user computing devices 204, e.g., the smartphone 112 of FIG. 1) to access application 206 (e.g., an application operating on the smartphone 112) or a user interface accessible through the application 206 via one or more networks 208 (e.g., the network 108 of FIG. 1). In some aspects, the application 206 may be hosted, managed, and/or provided by a computing resources service or service provider, such as by utilizing one or more service provider computers 210. The one or more service provider computers 210 may, in some examples, provide computing resources such as, but not limited to, client entities, low latency data storage, durable data storage, data access, management, virtualization, cloud-based software solutions, electronic content performance management, etc. The one or more service provider computers 210 may also be operable to provide web hosting, computer application development, and/or implementation platforms, combinations of the foregoing, or the like to the one or more users 202.

In some examples, the networks 208 may include any one or a combination of many different types of networks, such as cable networks, the Internet, wireless networks, cellular networks, and other private and/or public networks. While the illustrated example represents the users 202 accessing the application 206 over the networks 208, the described techniques may equally apply in instances where the users 202 interact with the service provider computers 210 via the one or more user computing devices 204 over a landline phone, via a kiosk, or in any other. suitable manner. It should be appreciated that the described techniques may apply in other client/server arrangements e.g., set-top boxes, etc.), as well as in non-client/server arrangements (e.g., locally stored applications, etc.).

As described briefly above, the application 206 may allow the users 202 to interact with the service provider computers 210 such as to access information associated with selling items via an electronic marketplace. The one or more service provider computers 210, perhaps arranged in a cluster of servers or as a server farm, may host the application 206 and/or cloud-based software services. Other server architectures may also be used to host the application 206 and/or cloud-based software services. The application 206 may be capable of handling requests from many users 202 and serving, in response, various user interfaces that can be rendered at the user computing devices 204 such as, but not limited to, perceived latency or the like. The application 206 can present any suitable type of website that supports user interaction, including search engine sites. As discussed above, the described techniques can similarly he implemented outside of the application 206, such as with other applications running on the user computing devices 204.

The user computing devices 204 (e.g., the smartphone 112 of FIG. 1) may be any suitable type of computing device such as, but not limited to, a mobile phone, a smartphone, a personal digital assistant (PDA), a laptop computer, a desktop computer, a thin-client device, a tablet PC, an electronic book (e-book) reader, etc. In some examples, the user computing devices 204 may be in communication with the service provider computers 210 via the networks 208, or via other network connections. Additionally, the user computing devices 204 may be part of the distributed system managed by, controlled by, or otherwise part of the service provider computers 210.

In one illustrative configuration, the user computing devices 204 may include at least one memory 212 and one or more processing units (or processor(s)) 214. The processor(s) 214 may be implemented as appropriate in hardware, computer-executable instructions, firmware, or combinations thereof Computer-executable instruction or firmware implementations of the processor(s) 214 may include computer-executable or machine-executable instructions written in any suitable programming language to perform the various functions described.

The memory 212 may store program instructions that are loadable and executable on the processor(s) 214, as well as data generated during the execution of these programs. Depending on the configuration and type of user computing device, the memory 212 may be volatile (such as random access memory (RAM)) and/or non-volatile (such as read-only memory (ROM), flash memory, etc.). The user computing devices 204 may also include additional removable storage and/or non-removable storage including, but not limited to, magnetic storage, optical disks, and/or tape storage. The disk drives and their associated computer-readable media. may provide non-volatile storage of computer-readable instructions, data structures, program modules, and other data for the computing devices. In some implementations, the memory 212 may include multiple different types of memory, such as static random access memory (SRAM), dynamic random access memory (DRAM), or ROM.

Turning to the contents of the memory 212 in more detail, the memory 212 may include an operating system and one or more application programs, modules, or services for implementing the features disclosed herein including at least the perceived latency, such as via the application 206 or dedicated applications (e.g., smart phone applications, tablet applications, etc.). The application 206 may be configured to receive, store, and/or display a network page or other interface for interacting with the service provider computers 210. Additionally, the memory 212 may store access credentials and/or other user information such as, but not limited to, user IDs, passwords, and/or other user information. In some examples, the user inthrmation may include information for authenticating an account access request such as, but not limited to, a device ID, a cookie, an IP address, a location, or the like. Additionally, the memory 212 may store a set of parameters associated with a geo-fence (e.g., the geo-fence 124 of FIG. 1).

In some aspects, the service provider computers 210 may also be any suitable type of computing devices such as, but not limited to, a mobile phone, a smart phone, a personal digital assistant (PDA), a laptop computer, a desktop computer, a server computer, a thin-client device, a tablet PC, etc. Additionally, it should be noted that in some embodiments, the service provider computers are executed by one more virtual machines implemented in a hosted computing environment. The hosted computing environment may include one or more rapidly provisioned and released computing resources, which computing resources may include computing, networking and/or storage devices. A hosted computing environment may also be referred to as a cloud-computing environment. In some examples, the service provider computers 210 may be in communication with the user computing devices 204 and/or other service providers via the networks 208 or via other network connections. The service provider computers 210 may include one or more servers, perhaps arranged in a cluster, as a server farm, or as individual servers not associated with one another. These servers may be configured to implement the content performance management described herein as part of an integrated, distributed computing environment.

In one illustrative configuration, the service provider computers 210 may include at least one memory 216 and one or more processing units (or processor(s)) 218. The processor(s) 218 may be implemented as appropriate in hardware, computer-executable instructions, firmware, or combinations thereof. Computer-executable instruction or firmware implementations of the processor(s) 218 may include computer-executable or machine-executable instructions written in any suitable programming language to perform the various functions described.

The memory 216 may store program instructions that are loadable and executable on the processor(s) 218, as well as data generated during the execution of these programs. Depending on the configuration and type of service provider computers 210, the memory 216 may be volatile (such as RAM) and/or non-volatile (such as ROM, flash memory, etc.). The service provider computers 210 or servers may also include additional storage 220, which may include removable storage and/or non-removable storage. The additional storage 220 may include, but is not limited to, magnetic storage, optical disks and/or tape storage. The disk drives and their associated computer-readable media may provide non-volatile storage of computer-readable instructions, data structures, program modules, and other data for the computing devices. In some implementations, the memory 216 may include multiple different types of memory, such as SRAM, DRAM, or ROM.

The memory 216, the additional storage 220, both removable and non-removable, are all examples of computer-readable storage media. For example, computer-readable storage media may include volatile or non-volatile, removable or non-removable media implemented in any method or technology for storage of information such as computer-readable instructions, data structures, program modules, or other data. The memory 216 and the additional storage 220 are all examples of computer storage media. Additional types of computer storage media that may be present in the service provider computers 210 may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the service provider computers 210. Combinations of any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The service provider computers 210 may also contain communications connection(s) 222 that allow the service provider computers 210 to communicate with a stored database, another computing device or server, user terminals and/or other devices on the networks 208. The service provider computers 210 may also include I/O device(s) 224, such as a keyboard, a mouse, a pen, a voice input device, a touch input device, a display, speakers, a printer, etc.

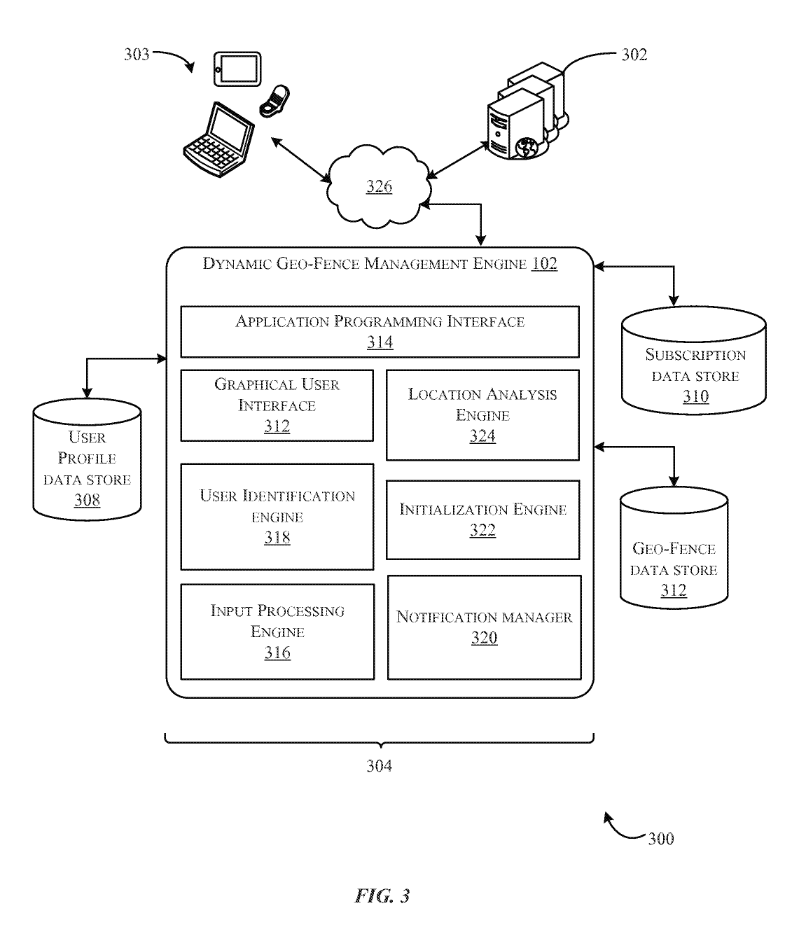

Turning to the contents of the memory 216 in more detail and will be described in further detail in FIG. 3, the memory 216 may include an operating system 226, one or more data stores 228, and/or one or more application programs, modules, or services for implementing the features disclosed herein including dynamic geo-fence management engine 102 of FIG. 1.

FIG. 3 schematically illustrates an example computer architecture 300 for the dynamic geo-fence management engine 102 of FIG. 1, including a plurality of modules 304 that may carry out various embodiments. The modules 304 may be software modules, hardware modules, or a combination thereof If the modules 304 are software modules, the modules 304 can be embodied on a computer readable medium and processed by a processor in any of the computer systems described herein. It should be noted that any module or data store described herein, may be, in some embodiments, a service responsible for managing data of the type required to make corresponding calculations. The modules 304 may be configured in the manner suggested in FIG. 3 or the modules 304 may exist as separate modules or services external to the dynamic geo-fence management engine 102. Any combination of modules 304 may be executed, in whole or in part, on service provider computers 302 (e.g., service provider computers 210 of FIG. 2). Likewise, any combination of modules 304 may be executed, in whole or in part, on user device 303 (e.g., the user computing devices 204 of FIG. 2), for example, as part of an application executing on user device(s) 303 (e.g., the application 206 of FIG. 2).

In the embodiment shown in the drawings, a user profile data store 306, a subscription data store 308, and a geo-fence data store 310 are shown, although data can be maintained, derived, or otherwise accessed from various data stores, either remote or local to the dynamic geo-fence management engine 102, to achieve the functions described herein. Some combination of the data stores depicted in FIG. 3 may be located on the service provider computers 302 and/or may be located on the user device(s) 303. The dynamic geo-fence management engine 102, shown in FIG. 3, includes various modules such as a graphical user interface 312, an application programming interface 314, an input processing engine 316, a user identification engine 318, a notification manager 320, an initialization engine 322, and a location analysis engine 324. Some functions of the modules 312, 314, 316, 318, 320, and 322 are described below. However, for the benefit of the reader, a brief, non-limiting description of each of the modules is provided in the following paragraphs.

In accordance with at least one embodiment, a process is enabled for utilizing the dynamic geo-fence management engine 102 of FIG. 1. For example, a user (e.g., the user 110 of FIG. 1) may utilize the user device(s) 303 to interact with service provider computers 302 provide subscription information via, for example, a network page managed by service provider computers 302. Subscription information is intended to include information related to a category of notifications (e.g., a topic category) that the user wishes to receive. For example, the user 110 may indicate (e.g., using the user device(s) 303) that he is interested in seeing notifications related to a particular merchant (e.g., any services/items offered by merchant A, a food truck offered by merchant A, a store operated by merchant A, etc.), a particular service (e.g., any food truck, any clothing store, any promotional deal, any yard sale, etc.), an item (e.g., an item purchased by the user and being delivered by, for example, a truck), and/or a geographical area (e.g., a user-specified radial distance corresponding, for example, to the user's current location or a user-specified location). As part of a user registration process, or at any suitable time (e.g., upon purchase of an item), subscription information regarding user notification preferences may be received by input processing engine 316 via graphical user interface 312 and application programming interface 314, both components of the dynamic geo-fence management engine 102. As a side, graphical user interface 312 and application programming interface 314 may be utilized in any suitable example described herein as a means for receiving by, or providing information by, dynamic geo-fence management engine 102.

In accordance with at least one embodiment, the input processing engine 316, a component of the dynamic geo-fence management engine 102, may be configured to receive input related to a geo-fence (e.g., a set of parameters including, but not limited to, a geo-fence identifier, a topic category, a message including text and/or image(s), an active time or time period, a radius, and/or a notification reset indicator) and/or input related to one or more subscriptions (e.g., identified using a user-specified topic category, determined using user purchase history, etc.). Upon receipt of such input, the input processing engine 316 may be configured to initiate one or more workflows with one or more components of the dynamic geo-fence management engine 102. For example, the input processing engine 316 may be configured to store such input in the user profile data store 306, the subscription data store 308, the geo-fence data store 310, or any suitable storage location.

In accordance with at least one embodiment, a user (e.g., a provider) that wishes to generate notifications related to his service/item (e.g., a yard sale) may provide information to the dynamic geo-fence management engine 102 indicating one or more topic categories (e.g., yard sales). Information related to the one or more topic categories may be received, for example, by input processing engine 316 and stored, for example, in subscription data store 308. Additionally, or alternatively, the dynamic geo-fence management engine 102 may utilize a predetermined set of topic categories stored, for example, in subscription data store 308.

In at least one example, a separate user (e.g., a consumer) may specify one or more topic categories for which he is interested in receiving notifications. For example, the consumer may utilize application 206 of FIG. 2, operating on user device(s) 303 to indicate that he is interested in receiving notifications related to a particular topic category (e.g., yard sales). Input processing engine 316 may store such information in, for example, user profile data store 306.

Continuing on with the example, at some point, the provider may wish to provide notifications to those users subscribed to his topic category. For example, the provider may decide to hold a yard sale on a particular day, for a particular time period. The provider may, utilizing application 206 of FIG. 2, communicate a set of parameters related to a geo-fence to dynamic geo-fence management engine 102. For example, the provider may utilize application 206 to specify geo-fence parameters including a message (e.g., “Stop by to check out my HUGE yard sale!! Family items, furniture, electronics, and more! Don't miss it” along with, or without, one or more images of the items of the yard sale), a center point location , the address of the yard sale), an active time (e.g., a start time of 8 AM and end time of 6 PM), an active date (e.g., the current date), a geo-fence category (e.g., yard sales) and a radius (e.g., 10 miles). In at least one example, the center point location may be obtained automatically using a component of the provider's device (e.g., a cellular antenna and/or a wireless antenna). Geo-fence parameters may be received by input processing engine 316 and communicated to user identification engine 318, or another suitable component of dynamic geo-fence management engine 102. In at least one example, such geo-fence parameters may he stored in geo-fence data store 310.

In at least one example, user identification engine 318 may interact with subscription data store 308 to obtain identification information for potentially interested users. For example, user identification engine 318 may determine a set of users that have previously subscribed to a particular topic category (e.g., yard sales). Additionally, or alternatively, user identification engine 38 may interact with user profile data store to determine potentially interested users. For example, user identification engine 318 may obtain contact information for every user, or some subset of the users corresponding to user information stored in user profile data store 306. Additionally, or alternatively, the user identification engine 318 may determine users who share a common trait (e.g., users who live in a particular area or zip code). Regardless of the method employed by user identification engine 318, identification/contact information for the identified users and the geo-fence parameters may be communicated to, or otherwise obtained by, notification manager 320, another component of dynamic geo-fence management engine 102. Continuing with the yard sale example provided above, user identification engine 318, utilizing information contained in subscription data store 308, may identify the consumer due to the consumer being subscribed to the topic category “yard sales.” As a result, the consumer's identification information may be communicated to the notification manager 320.

Upon receipt of user identification information, or at any suitable time, the notification manager 320 may utilize the user identification information and the goo-fence parameters to generate a number of notifications. For example, the notification manager 320 may format the geo-fence parameters according to a push notification service protocol to generate one or more push notifications. The notification manager 320 may address the one or more push notifications or enable a remote push notification service to address the one or more push notifications. The notification manager 320, upon concluding the formatting process, may transmit the one or more push notifications to a push notification service that is remote with respect to the dynamic geo-fence management engine 102. In at least one example, notification manager 320 may further be responsible for the deletion of geo-fence parameters. For example, geo-fence parameters may specify a time at which the geo-fence should be deleted. Upon detecting that the specified time has arrived, notification manager 320 may be responsible for formatting one or more notification according to a push notification service protocol, the one or more notifications including information to cause deletion of geo-fence parameters (e.g., from local memory of a user device). Additionally, or alternatively, the notification manager 320 may cause geo-fence parameters to be deleted from geo-fence data store 310 using an additional push notification for deletion purposes. Additionally, or alternatively, previously stored goo-fence parameters may be deleted due to receipt of new geo-fence parameters.

Continuing with the yard sale example provided above, the notification manager 320 may format the geo-fence parameters received from the provider according to a push notification service protocol in order to generate a push notification request. The consumer's identification information may be included the push notification request as the consumer was identified by user identification engine 318. The notification manager 320 may transmit, or otherwise communicate, the push notification request to a push notification service responsible for generating push notifications over a network (e.g., network 326) to the user device(s) 303,

Initialization engine 322, a component of the dynamic geo-fence management engine 102, may reside on service provider computers 302, or user device(s) 303 (e.g., a user device of the consumer). In at least one example, the initialization engine 322 may be a component remote to the dynamic geo-fence management engine 102 (e.g., a component of application 206 of FIG. 2 operating on the consumer's device). The initialization engine 322 may receive one or more push notifications including the geo-fence parameters or a subset of the geo-fence parameters. Upon receipt, or at any suitable time, the initialization engine 322 may cause such geo-fence parameters to be stored, for example, in geo-fence data store 310, a data store responsible for storing such information. In at least one example, geo-fence data store 310 may be local memory residing on the consumer's device.

In the current yard sale example, an application operating on the consumer's device may receive a push notification including geo-fence parameters related to the provider's yard sale. A component of the application (e.g., the initialization engine 322) may store the geo-fence parameters in the geo-fence data store 310 (e.g., a data store residing on the consumer's device). Storage of the geo-fence parameters may constitute initialization of a geo-fence with respect to the application.

Location analysis engine 324, a component of the dynamic geo-fence management engine 102, may reside on service provider computers 302, or user device(s) 303 (e.g., a user device of the consumer). In at least one example, the location analysis engine 324 may be a component remote to the dynamic geo-fence management engine 102 (e.g., a component of application 206 of FIG. 2 operating on the consumer's device). The location analysis engine 324 may receive user location information (e.g., cellular triangulation information, wireless network identification information, global positioning system coordinates, or the like) indicating a location of a user. Utilizing user location information and stored geo-fence parameters, the location analysis engine may determine that the user device is located within an area defined by the geo-fence parameters. Upon making such a determination, the location analysis engine 324 may cause a notification and/or alert to be provided on the user device(s) 303 (e.g., via notification manager 320 or by any suitable method).

Continuing with the yard sale example from above, the location analysis engine 324, a component of dynamic geo-fence management engine 102, may operate on the consumer's device (e.g., via application 206 of FIG. 2). The consumer may be, for instance, driving around town looking for yard sales. Upon passing through the perimeter of the geo-fence (as detected by location analysis engine 324, the perimeter being defined by a 10 mile radius of the yard sale address) a notification (e.g., a local push notification) may be initiated on the consumer's device, alerting the consumer to the yard sale located nearby.

Although examples herein may discuss a directional flow from the provider to the consumer, it should be appreciated that any example herein may utilize an opposite flow. For example, a location of a user device may be received by the location analysis engine 324. A merchant, for example, having previous indicated interest in a particular user (e.g., a valued customer), may be identified by user identification engine 318. User identification engine 318 may cause notification manager 320 to generate a notification (e.g., a push notification, an electronic message, etc.) to be provided to the merchant's device. In this manner, the merchant may be alerted to the presence of the valued customer. This may be beneficial, for example, for a merchant who desires to be notified when a valued customer enters his store.

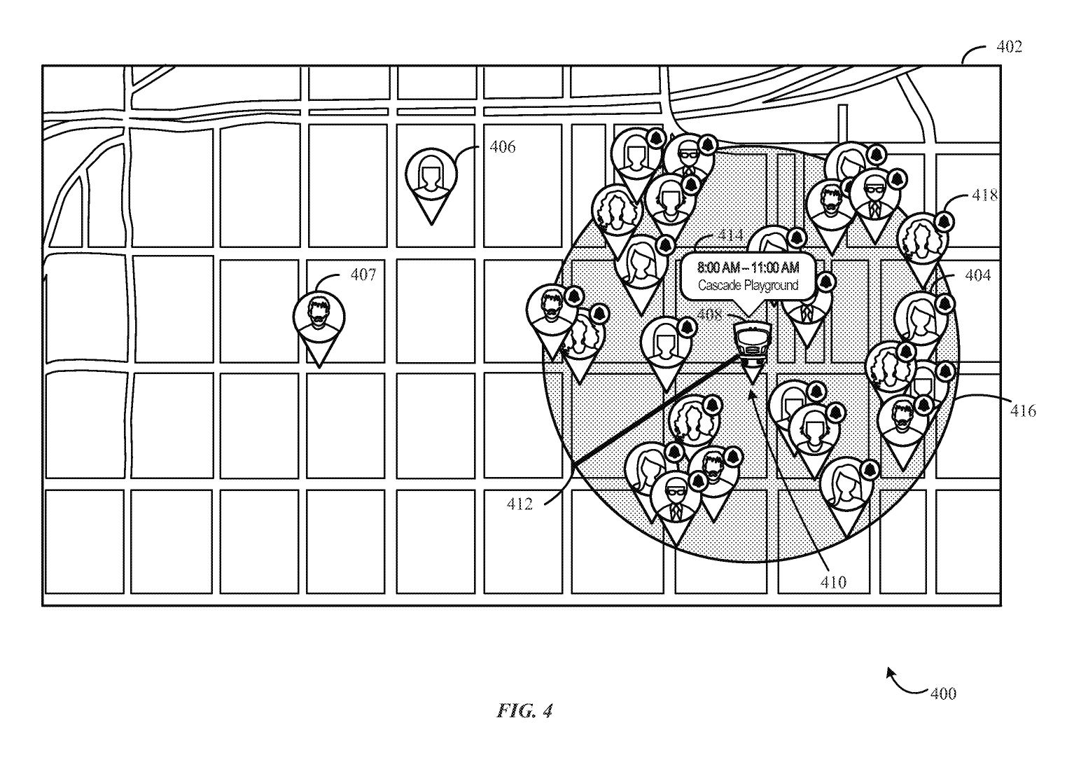

FIG. 4 is a schematic diagram illustrating an example environment 400 suitable for implementing aspects of the dynamic geo-fence management engine 102. of FIG. 3, in accordance with at least one embodiment. Consider that a number of users are located at various locations throughout a geographical area (e.g., area 402). For simplicity, users 404 are used as an example, though there may be a variety of other users located at various locations e.g., user 406 and user 407 throughout the area 402. Assume, for the purpose of this example, that users 404 have previously subscribed to a topic category related to service (e.g., a service provided by merchant truck 408). Merchant truck 408 is used for illustrative purposes only, other resources, mobile (e.g., a passenger bus, a train, a plane, or the like) or stationary (e.g., a statically located store, a yard sale, etc.), may be utilized. Such resources may be substituted for any example included herein.

In accordance with at east one example, the merchant truck 408 may arrive at location 410. Upon arrival, or at another suitable time, a driver of the merchant truck 408 may communicate (e.g., via an application programming interface, by telephone, by SMS message, etc.) geo-fence parameters associated with the merchant truck 408. For example, geo-fence parameters may include a radial distance as depicted at 412. For illustrative purposes, the radial distance 412 is meant to radiate from a center point depicted by the location 410 of the merchant truck 408, Additional geo-fence parameters may include a time period (e.g., 8:00 AM to 11:00 PM), a location (e.g., cascade playground), among others.

The geo-fence parameters may be received by dynamic geo-fence management engine 102 (e.g., via input processing engine 316 of FIG. 3). Such information may be communicated to, for example, user identification engine 318 of FIG. 3. User identification engine 318 may determine a number of potentially interested users (e.g., users 404, all users depicted with the area defined by location 410 and radial distance 412) based at least in part on, for example, previously stored subscription information of users 404 (e.g., stored in subscription data store 308 of FIG. 3). As a non-limiting example, geo-fence parameters may include, or may be associated with, a topic category (e.g., merchant A, merchant truck 108, “FOOD”, etc.). User identification engine 318 may, upon determining that the geo-fence parameters relate to, for example, merchant A, determine a number of users that have previously indicated that they are interested in the topic category “merchant A.” Alternatively, user identification engine 318 may determine all known users should be notified (e.g., users 404, user 406, user 407, and all users not depicted). Alternatively, user identification engine 318 may determine that a subset of users (e.g., ones for which stored shipping information is located with a threshold distance of the location 410, for example, user 406 but not user 407) should be notified. For example, a user may have previously indicated an address (e.g., a shipping address, a work address, a home address, or the like), the address including a particular zip code. Upon determining that the geo-fence parameters relate to a same zip code (or a zip code within a threshold distance of the user's zip code), User identification engine 318 may identify the user as being a user to be notified of the existence of one or more geo-fences.

Upon identifying the users to be notified, user identification engine 318 may communicate geo-fence parameters to, for example, the notification manager 320 of FIG. 3. The notification manager 320 may, in a similar manner as described above, format and provide geo-fence parameters and user identification information to a push notification service for dissemination to the users 404.

Upon receipt of the push notification, an application running on each user device of users 404 may initiate a geo-fence 416 corresponding to the merchant truck 408. The user device, upon a determination of user location (e.g., using cellular triangulation and/or wireless network identification information) may determine (e.g., using location analysis engine 324) that the user is located within geo-fence 416. Upon such a determination, the application running on each user device may generate (or otherwise cause generation of) a notification to be presented on the user device (e.g., the push notification 120 of FIG. 1) as depicted by notification 418. The notification may be graphical, audible, or haptic.

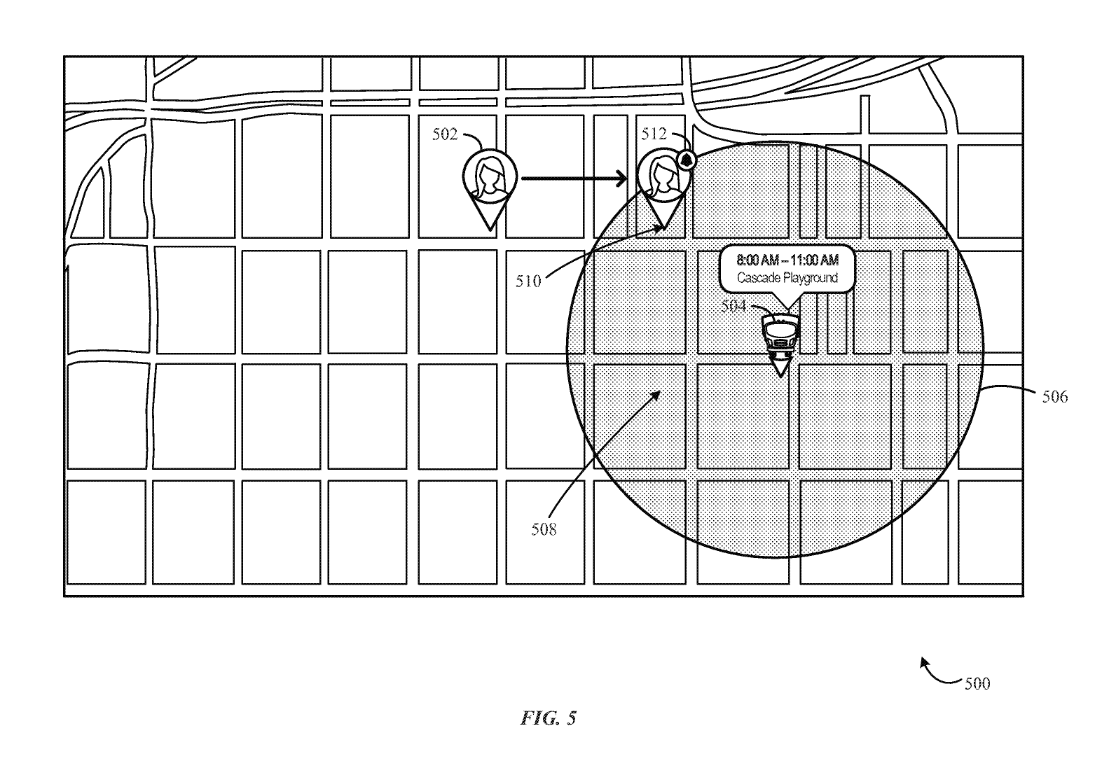

FIG. 5 is a schematic diagram illustrating another example environment 500 suitable for implementing aspects of the dynamic geo-fence management engine 102 of FIG. 3, in accordance with at least one embodiment. For this example, assume a user 502 has subscribed to a topic category related to merchant truck 504. At some suitable time, a geo-fence 506 is initiated in a similar manner (e.g., by push notification) as described above, the geo-fence 506 defining the area 508. The user 502 may be located at location 510 at a time before or after geo-fence 506 is initiated. Upon initialization of the geo-fence 506, the user's device may receive geo-fence parameters and store such parameters locally. While the user is located at location 510, or any location outside of area 508 defined by geo-fence 506, the user may not be presented any notification regarding merchant truck 504. However, upon crossing a perimeter defined by 506, or otherwise being located at a location within area 508, the user may be alerted (e.g., via notification 512, a local push notification, email, text message, or the like) that merchant truck 504 is nearby.

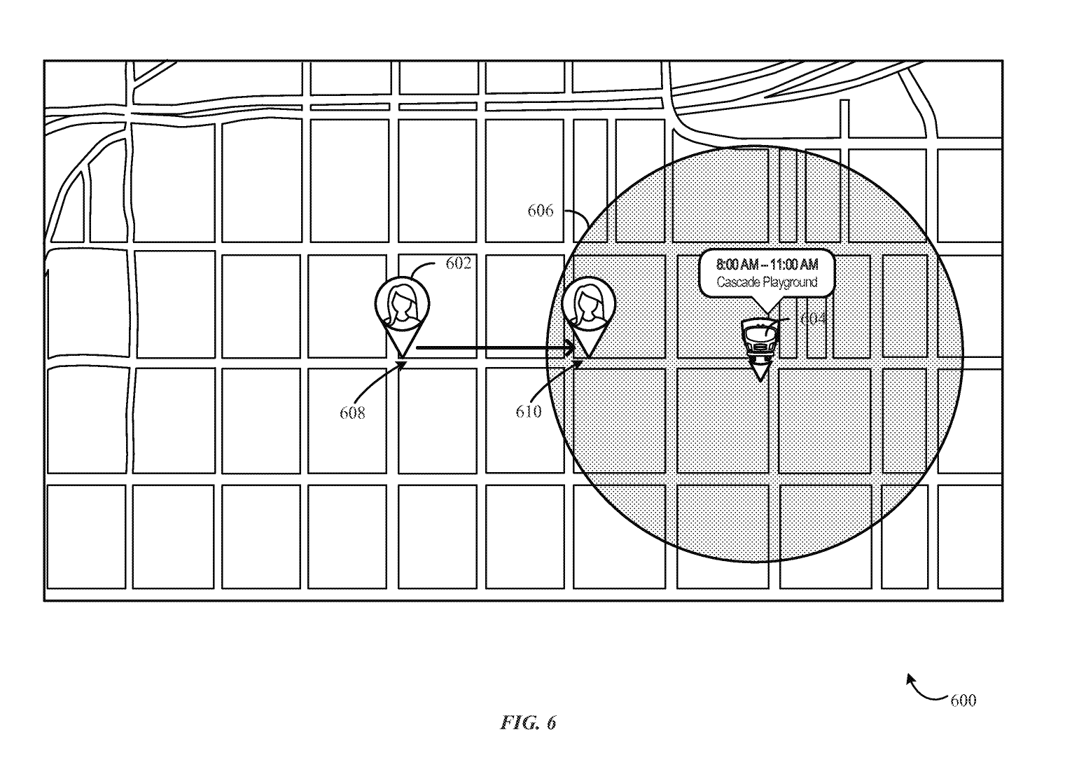

FIG. 6 is a schematic diagram illustrating an additional example environment 600 suitable for implementing aspects of the dynamic geo-fence management engine 102 of FIG. 3, in accordance with at least one embodiment. For this example, assume a user 602 has subscribed to a topic category related to the merchant truck 604, or has otherwise indicated interest in the merchant truck 604. At some suitable time, a geo-fence 606 is initiated in a similar manner as described above. The user 602 may be located at location 608 at a time before or after geo-fence 606 is initiated. Upon initialization of the geo-fence 606, the user's device may receive geo-fence parameters and store such parameters locally. While the user is located at location 608 the user may not be presented any notification regarding merchant truck 604. Typically, by crossing a perimeter defined by geo-fence 606, the user may be notified that merchant truck 604 is nearby. However, the user identification engine 318 of FIG. 3, or other suitable component of the dynamic geo-fence management engine 102 of FIG. 1, may utilize the past purchase information (e.g., stored in user profile data store 306 of FIG. 3) to suppress any notification to the user 602. As a non-limiting example, the user 602 may have already purchased an item offered by the merchant truck 604 or may have already received a notification regarding the merchant truck 604 (e.g., earlier that day). Given such information, the user 602 may not be presented with a notification.

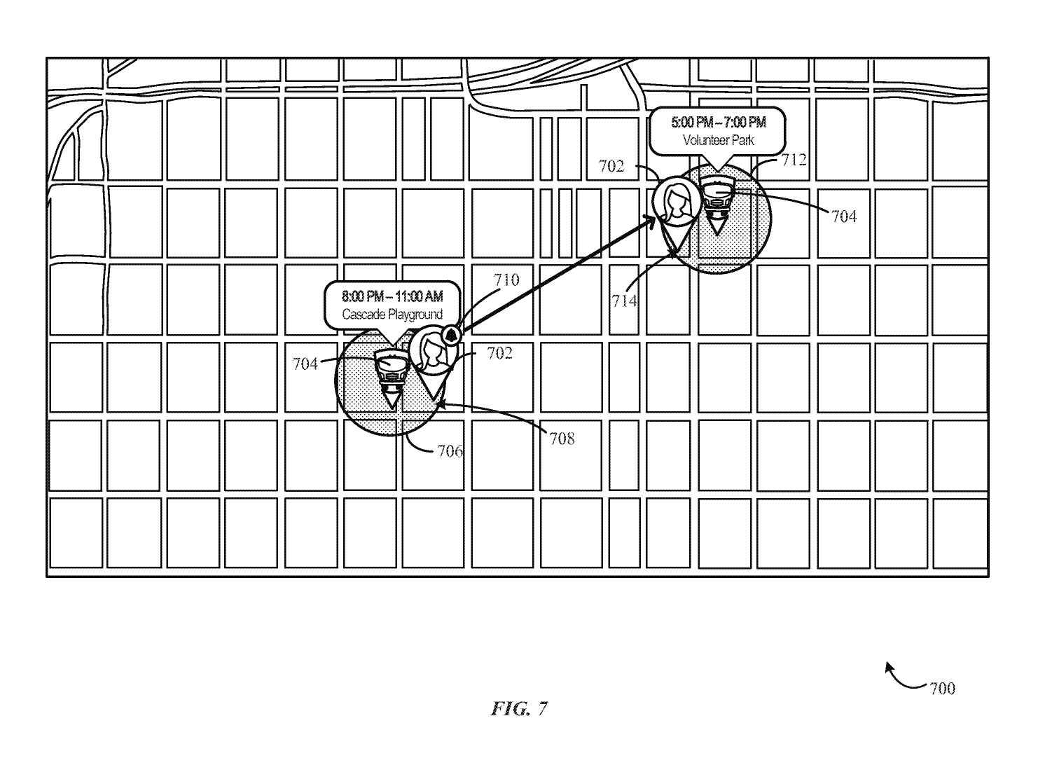

FIG. 7 is a schematic diagram illustrating yet another example environment 700 suitable for implementing aspects of the dynamic geo-fence management engine 102 of FIG. 3, in accordance with at least one embodiment. For this example, assume that the user 702 has subscribed to a topic category related to merchant truck 704 as described above or, alternatively, provided other information (e.g., user profile information including shipping address, billing address, purchase history, location history, and the like) to dynamic geo-fence management engine 102. At some suitable time after initialization of geo-fence 706, for example, upon arriving at location 708, a notification 710 may be provided to the user 702 using a device operated by the user e.g., the smartphone 112 of FIG. 1).

Consider now, that the merchant truck 704, or another mobile or stationary resource, arrives at different location and establishes the geo-fence 712. In at least one example, establishing, or otherwise initializing the geo-fence 712 may cause deletion information related to geo-fence 706. Alternatively, geo-fence 706 may be deleted from memory after a determinate period of time (e.g., upon reaching an end time, here depicted as 12:00 AM). Now consider that the user 702 has moved to location 714. In at least one example, although the geo-fence 712 has been initialized and is known to the device of user 702, given that the user 702 has previously, received notification 610, no new notification may be presented to user 702 regarding geo-fence 712. In at least one example, the user 702 may not receive a notification regarding geo-fence 712 due to a previous purchase (e.g., when the user 702 has purchased an item from merchant truck 604 when the merchant truck 704 was located within geo-fence 706, or purchased an item from the merchant in general within a threshold time period). Thus, the previous purchase information may be utilized (e.g., by notification manager 320 of FIG. 3 or another suitable component of the dynamic geo-fence management engine 102 of FIG. 1) in order to suppress (e.g., for the remainder of the current day or some other suitable time period) further notifications to the user regarding the merchant truck 704. In this manner, user experience is improved as the user 702 is not unnecessarily harassed with multiple notifications that are unlikely to be of interest to the user 702. In yet another example, the user 702 may be notified of both geo-fence 706 as well as geo-fence 712 regardless of previous notifications and/or previous purchases.

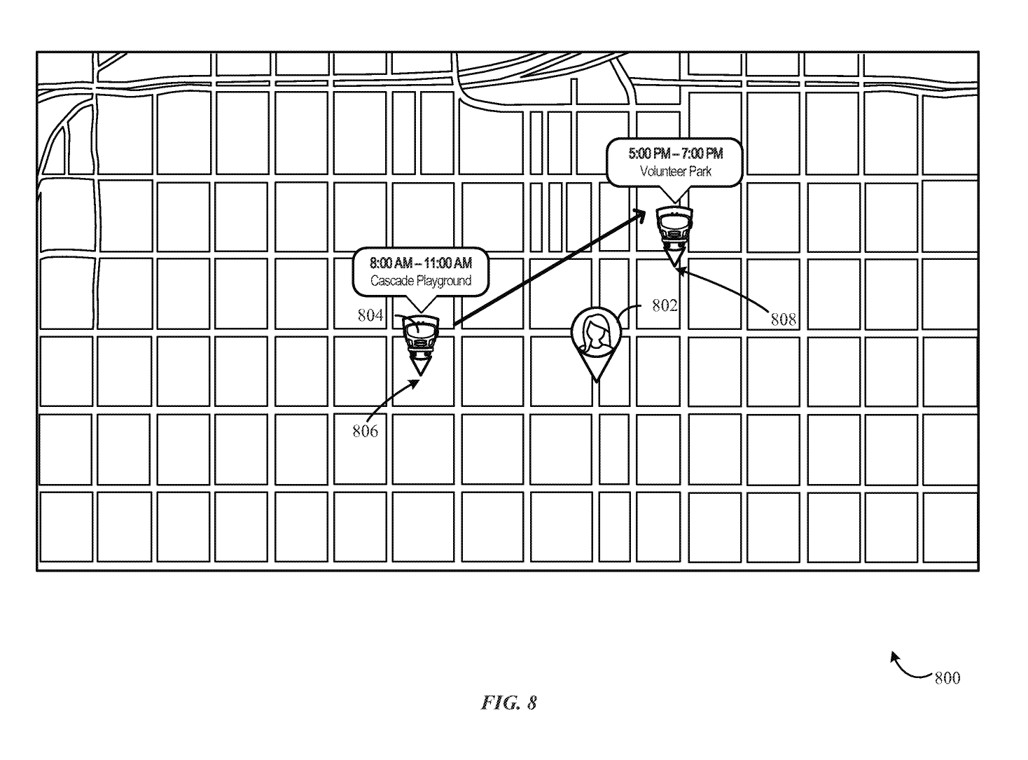

FIG. 8 is a schematic diagram illustrating still one further example environment 800 suitable for implementing aspects of the dynamic geo-fence management engine 102 of FIG. 3, in accordance with at least one embodiment. Consider the case where user 802 has subscribed to a topic category related to merchant truck 804. Now further consider that merchant truck 804 is in transit from location 806 to location 808. In at least one example, user 802 will not receive any notifications related to the merchant truck 804 as merchant truck 804 passing by the user 802. In such examples, user 802 may potentially only be notified when the merchant truck 804 is stationary and a geo-fence is initialized.

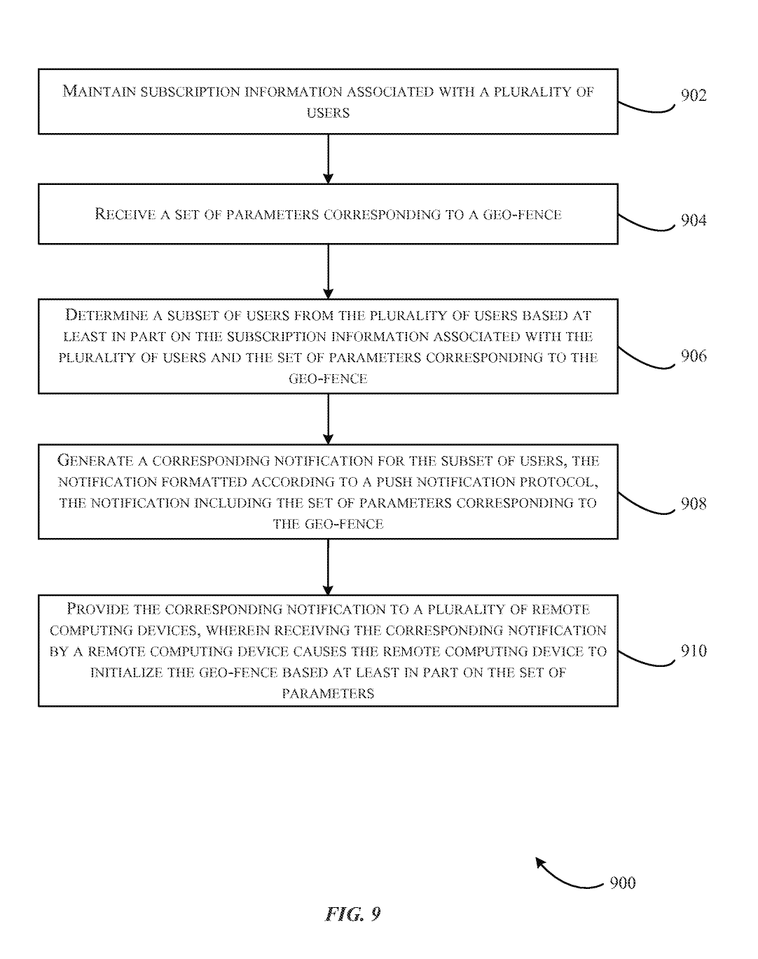

FIG. 9 is a flowchart illustrating a method 900 for dynamically managing a geo-fence utilizing the dynamic geo-fence management engine 102 of FIG. 3, in accordance with at least one embodiment. The method 900 may begin at block 902, where subscription information associated with a plurality of users may be maintained by one or more data processors (e.g., one or more data processors, such as hardware computer processors (e.g., ‘CPUs’), executing instructions related to the dynamic geo-fence management engine 102 of FIG. 1). At block 904, a set of parameters corresponding to a geo-fence may be received (e.g., by the input processing engine 316 of FIG. 3).

At block 906, a subset of users from the plurality of users may be determined (e.g., by the user identification engine 318 of FIG. 3). The subset of users may be determined based at least in part on the subscription information (e.g., user-specified topic categories) associated with the plurality of users and the set of parameters corresponding to the geo-fence.

At block 908, a corresponding notification may be generated (e.g., by the notification manager 320 of FIG. 3) tier the subset of users, the notification being formatted according to a push notification service protocol, the notification including the set of parameters corresponding to the geo-fence.

At block 910, the corresponding notification may be provided to a plurality of remote computing devices (e.g., by the notification manager 320 of FIG. 3). In at least one example, the remote computing devices are remote with respect to the one or more data processors. In at least one example, receiving the corresponding notification by a remote computing device causes the remote computing device to initialize (e.g., using the initialization engine 322 of FIG. 3) the geo-fence based at least in part on the set of parameters.

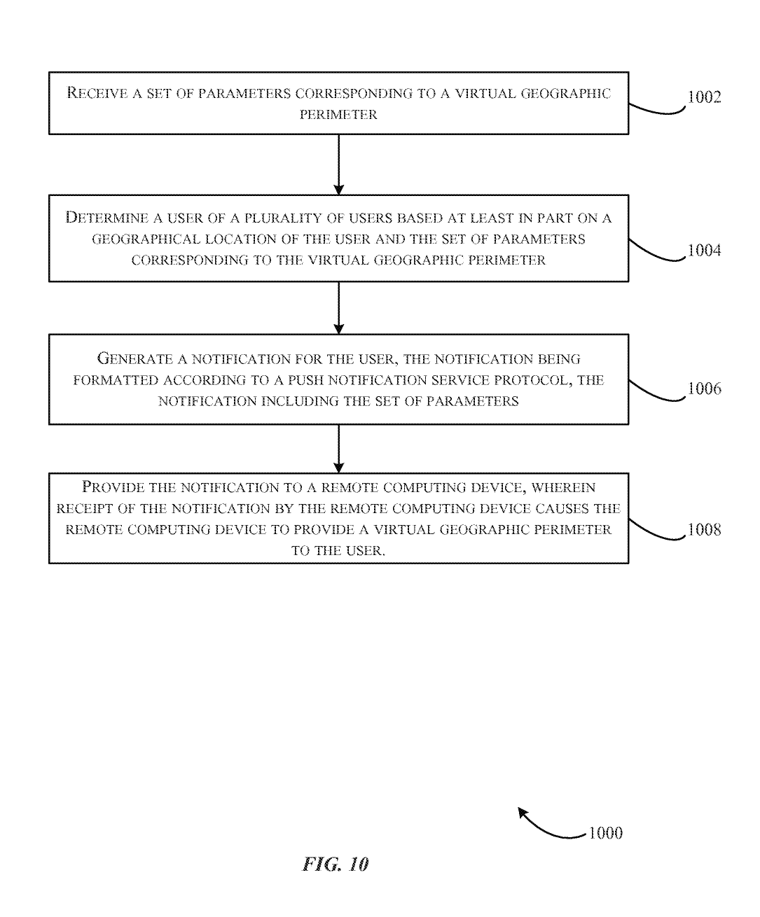

FIG. 10 is a flowchart illustrating another method 1000 for dynamically managing a geo-fence utilizing the dynamic geo-fence management engine 102 of FIG. 3, in accordance with at least one further embodiment. The method 1000 may begin at block 1002, where a set of parameters corresponding to a virtual geographic perimeter may be received (e.g., by the input processing engine 316 of FIG. 3).

At block 1004, a user of a plurality of users may be determined (e.g., by the user identification engine 318 of FIG. 3) based at least in part on a geographical location of the user and the set of parameters corresponding to the virtual geographic perimeter.

At block 1006, a notification for the user may be generated (e.g., by the notification manager 320 of FIG. 3), the notification being formatted according to a push notification service protocol the notification including the set of parameters.

At block 1008, the notification may be provided to a remote computing device (e.g., by the notification manager 320 of FIG. 3), wherein the remote computing device is remote with respect to a processor of the system, and wherein receipt of the notification by the remote computing device causes the remote computing device to provide information related to the virtual geographic perimeter to the user.

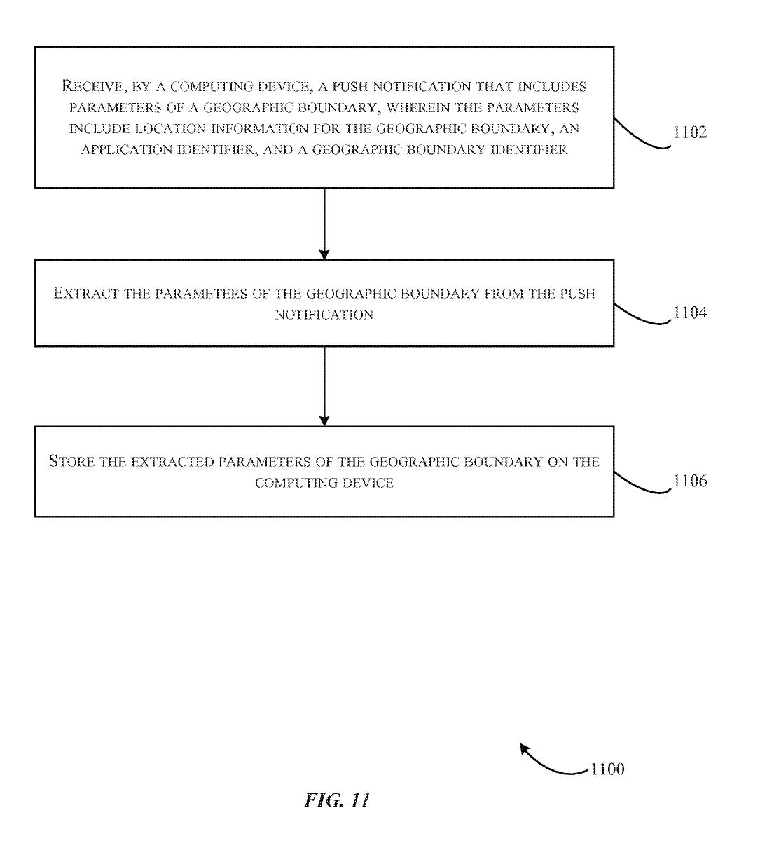

FIG. 11 is a flowchart illustrating another method 1100 for dynamically managing a geo-fence utilizing the dynamic geo-fence management engine 102 of FIG. 3, in accordance with at least one further embodiment. The method 1100 may begin at block 1102, where a push notification that includes parameters of a geographic boundary may be received by the computing device. The push notification may be received from a push notification service and initiated by the dynamic geo-fence management engine 102. The geographic boundary parameters included in the push notification include location information for the geographic boundary, an application identifier, and a geographic boundary identifier. Additional parameters, such as text or graphical image(s) may be included as parameters in the push notification.

At block 1104, the parameters of the geographic boundary may be extracted from the push notification (e.g., by the initialization engine 322. of FIG. 3 operating on the computing device).

At block 1108, the extracted parameters of the geographic boundary may be stored on the computing device. In at least one example, the extracted parameters may be later utilized by an application to provide notifications/alerts to a user regarding the geographic boundary,

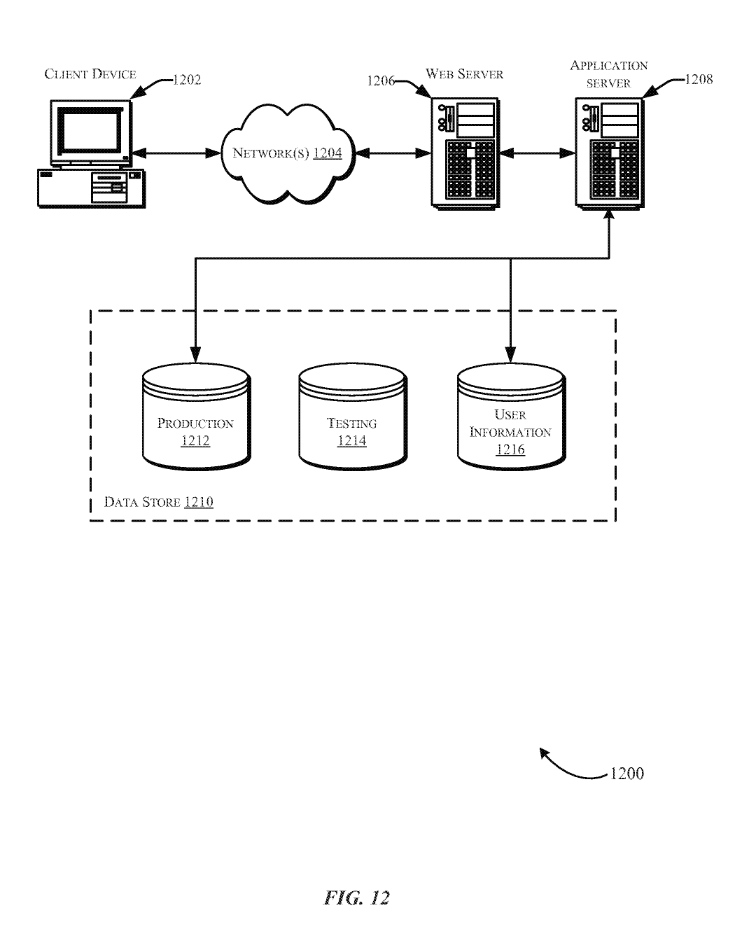

FIG. 12 illustrates aspects of an example environment 1200 for implementing aspects in accordance with various embodiments. As wilt be appreciated, although a Web-based environment is used for purposes of explanation, different environments may be used, as appropriate, to implement various embodiments. The environment includes a user device 1202 (e.g., an electronic client device), which can include any appropriate device operable to send and receive requests, messages, or information over an appropriate network 1204 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 1206 for receiving requests and serving content in response thereto, although for other networks an alternative device serving a similar purpose could be used as would be apparent to one of ordinary skill in the art.

The illustrative environment includes at least one application server 1208 and a data store 1210. It should be understood that there can be several application servers, layers, or other elements, processes, or components, which may be chained or otherwise configured, which can interact to perform tasks such as obtaining data from an appropriate data store, As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio, and/or video to he transferred to the user, which may be served to the user by the Web server in the form of HyperText Markup Language (“HTML”), Extensible Markup Language (“XML”), or another appropriate structured language in this example. The handling of all requests and responses, as well as the delivery of content between the user device 1202 and the at least one application server 1208, can be handled by the Web server. It should be understood that the Web and application servers are not required and are merely example components, as structured code discussed herein can be executed on any appropriate device or host machine as discussed elsewhere herein.

The data store 1210 can include several separate data tables, databases or other data. storage mechanisms and media for storing data relating to a particular aspect. For example, the data store illustrated includes mechanisms for storing production data 1212 and user information 1216, which can be used to serve content for the production side. The data store also is shown to include a mechanism for storing tog data 1214, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 1210. The data store 1210 is operable, through logic associated therewith, to receive instructions from the at least one application server 1208 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the user device 1202. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality attic servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 12. Thus, the depiction of the environment 1200 in FIG. 12 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, well as combinations thereof The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
maintaining, by one or more data processors, subscription information associated with a plurality of users;
receiving a set of parameters corresponding to a geo-fence;
determining a subset of users from the plurality of users based at least in part on the subscription information associated with the plurality of users and the set of parameters corresponding to the geo-fence;
generating a corresponding notification for the subset of users, the notification being formatted according to a push notification service protocol, the notification including the set of parameters corresponding to the geo-fence; and
providing the corresponding notification to a plurality of remote computing devices, wherein the remote computing devices are remote with respect to the one or more data processors, and wherein receiving the corresponding notification by a remote computing device causes the remote computing device to initialize the geo-fence based at least in part on the set of parameters.

2. The computer-implemented method of claim 1, wherein the set of parameters include at least one of a start time, an end time, a period of time, a geographical center point, a textual message, a graphic, or a distance measurement.

3. The computer-implemented method of claim 11, wherein the subscription information identifies a topic of interest to the user.

4. The computer-implemented method of claim 1, further comprising:
determining an interest category for the geo-fence, wherein determining the subset of users from the plurality of users is further based at least in part on the interest category for the geo-fence.

5. A system, comprising:
a processor; and
a memory storing computer-executable instructions that, when executed with the processor, cause the system to at least:
receive a set of parameters corresponding to a virtual geographic perimeter;
determining a user of a plurality of users based at least in part on a geographical location associated with the user and the set of parameters corresponding to the virtual geographic perimeter;
generate a notification for the user, the notification being formatted according to a push notification service protocol, the notification including the set of parameters; and
provide the notification to a remote computing device, wherein the remote computing device is remote with respect to the processor, and wherein receipt of the notification by the remote computing device causes the remote computing device to provide information related to the virtual geographic perimeter to the user.

6. The system of claim 5, wherein determining the user is further based at least in part on at least one of a category of interest associated with the user, a perimeter category associated with the virtual geographic perimeter, a user preference, a number of notifications received by the user within a time period, or previous purchase information of the user.

7. The system of claim 5, wherein the memory includes further instructions that, when executed with the processor, cause the system to at least:
determine an additional user of the plurality of users based at least in part on a geographical location of the additional user and the set of parameters corresponding to the virtual geographic perimeter;
determine that at east one notification has been sent to the additional user within a preceding time period; and
restrict generation of an additional notification based at least in part on the determination that the at least one notification has been sent to the additional user within the preceding time period.

8. The system of claim 5, wherein the memory includes further instructions that, when executed with the processor, cause the system to at least:
determine that an active time period for the virtual geographic perimeter has elapsed,
generate a removal notification for the virtual geographic perimeter, the removal notification being formatted according to the push notification service protocol; and
provide the removal notification to a remote computing device, wherein the receipt of the notification by the remote computing device causes the remote computing device to remove the information related to the virtual geographic perimeter from the remote computing device.

9. The system of claim 5, wherein the memory includes further instructions that, when executed with the processor, cause the system to at least:
receive an update to the set of parameters corresponding to the virtual geographic perimeter;
generate an update notification for the virtual geographic perimeter, the update notification being formatted according to the push notification service protocol; and
provide the update notification to a remote computing device, wherein the receipt of the notification by the remote computing device causes the remote computing device to update the information related to the virtual geographic perimeter.

10. The system of claim 5, wherein the virtual geographic perimeter is associated with a mobile marketplace.

11. The system of claim 10, wherein providing the notification is based at least in part on a determination that the user has purchased an item located on the mobile marketplace.

12. The system of claim 5, wherein determining the user of the plurality of users is further based at least in part on historical geographic information of the user.

13. A computer-implemented method, comprising:
receiving, by a computing device, a push notification that includes parameters of a geographic boundary, wherein the parameters include location information for the geographic boundary, an application identifier, and a geographic boundary identifier;
extracting the parameters of the geographic boundary from the push notification; and
storing the extracted parameters of the geographic boundary on the computing device.

14. The computer-implemented method of claim 13, further comprising:
obtaining, by the computing device, location information for the computing device;
comparing the location information with the stored parameters of the geographic boundary; and
providing, by the computing device, an indication to the user based at least in part on the comparison.

15. The computer-implemented method of claim 14, wherein the indication to the user is provided by an application executing on the computing device, and wherein providing the indication occurs independent of user interaction with the application.

16. The computer-implemented method of claim 13, wherein the push notification is initiated by a push notification service separate from the computing device.

17. The computer-implemented method of claim 13, wherein the location information for the geographic boundary includes a geographic center point and a radius.

18. The computer-implemented method of claim 13, wherein the parameters for the geographic boundary included in the push notification further include a textual message or graphical image.

19. The computer-implemented method of claim 13, wherein the application identifier comprises a unique identifier associated with the application.

20. The computer-implemented method of claim 13, wherein the geographic boundary identifier comprises a unique identifier associated with the geographic boundary.
